(19) United States
(12) Patent Application Publication
(10) Pub. No.: US 2002/0124249 A1
(43) Pub. Date: Sep. 5, 2002

(54) Targeted advertising during playback of stored content

(76) Inventors: Peter Rae Shintani, San Diego, CA (US); Matthew S. Chang, San Diego, CA (US); Aditya Krishnan, San Diego, CA (US); Andrew M. Proehl, San Francisco, CA (US); David K.L. Yang, San Jose, CA (US); Fred J. Zustak, Poway, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/752,968

(22) Filed: Jan. 2, 2001

(51) Int. Cl. H04N 7/025; H04N 7/10; H04N 7/173

(52) U.S. Cl. 725/32; 725/105; 725/131

(57) ABSTRACT

An advertising technique for use during playback of stored entertainment content. A set-top box notifies a service provider of the selection of playback of stored content by a user. The service provider uses user profile information and other information to select targeted advertisements for the user and the advertisements are merged with the stored content for presentation to the user.

### FIELD OF THE INVENTION

This invention relates generally to the field of advertising. More particularly, this invention relates to a method of enhancing the effectiveness of advertising during a playback of stored entertainment content.

### BACKGROUND OF THE INVENTION

Video Cassette Recorders (VCRs) have enabled users to readily record and play back television programming, movies and other entertainment content for a number of years. Video Cassette Recorders (and other Video Tape Recorders (VTRs)) are linear devices that begin recording at a starting point of the tape and commence linearly until the recording is terminated by the end of the tape or by user or automated intervention to halt the recording. Playback is similarly a linear process with a starting and ending point on the tape. When television programming is recorded, advertisements appearing in the programming at the time of recording are typically also recorded and are thus presented again for viewing during the playback of the recorded programming.

As the storage capacity, cost per Megabyte and speed of nonlinear (random access) recording media such as hard disc drives and optical disc drives has improved, such devices have begun to replace the linear tape-based recording media. Set-top boxes using hard disc drives to record, store and play back content are expected to emerge as the next generation of video recording devices. Several stand-alone devices that use disc drive storage for recording and playback of content, referred to as Personal Video Recorders (PVRs), are now available from Sony Corporation, Tivo Corporation and others. As the capabilities of Television Set-top boxes increases, it is anticipated that STBs using nonlinear storage will form the core of a home entertainment system and include the recording capabilities of the stand-alone disc-based record/playback devices (e.g., PVRs) currently on the market. Standalone PVR devices and disc drive storage systems are also being designed to actively interact with STB systems to form storage for home networks. The nonlinear nature of disc storage used for storage of programming materials facilitates scanning and manipulation of the content.

### SUMMARY OF THE INVENTION

The present invention relates generally to advertising. Objects, advantages and features of the invention will become apparent to those skilled in the art upon consideration of the following detailed description of the invention.

One embodiment of the present invention relates to an advertising technique for use during the playback of stored entertainment content. A set-top box notifies a service provider of the selection of playback of stored content by a user. The service provider uses user profile information and other information to select targeted advertisements for the user and the advertisements are merged with the stored content for presentation to the user.

A method of playback of stored entertainment content consistent with certain embodiments of the invention include: notifying a service provider of a playback of the stored entertainment content; receiving an advertisement from an advertising server; and merging the advertisement with the stored entertainment content so that both the advertisement and the stored entertainment content are played back.

In another embodiment consistent with the present invention, a method of delivering advertisements to a user includes: receiving a message from a set-top box indicating initiation of the playback of stored entertainment content; selecting an advertisement based on a user profile for the user; and transmitting the advertisement to the set-top box to be merged with the entertainment content.

An exemplary set-top box consistent with embodiments of the present invention includes an input interface receiving a signal indicating that a user has initiated a playback of stored entertainment content. A service provider is notified by the STB of the initiation of the playback of stored entertainment content. A selected advertisement is received from the service provider. A programmed processor merges the selected advertisement with the entertainment content so that the entertainment content is played back with the selected advertisement.

An exemplary system for delivery of advertisements consistent with the present invention includes a mechanism for receiving a message from a set-top box indicative of a user's selection of playback of stored entertainment content. A user profile server stores a user profile of the user. An advertisement server receives the user profile and supplies an advertisement selected in accordance with the user profile. The advertisement is transmitted to the set-top box for merging at playback with the entertainment content.

An electronic storage medium consistent with one embodiment of the invention stores instructions which, when executed on a programmed processor, carry out a process of playback of stored entertainment content includes: notifying a service provider of a playback of the stored entertainment content; receiving an advertisement from an advertising server; and merging the advertisement with the stored entertainment content so that both the advertisement and the stored entertainment content are played back.

Another electronic storage medium consistent with embodiments of the invention stores instructions which, when executed on a programmed processor, carry out a process of delivering advertisements to a user including: receiving a message from a set-top box indicating initiation of playback of stored entertainment content; selecting an advertisement based on a user profile for the user; and transmitting the advertisement to the set-top box to be merged with the entertainment content.

A method of doing business using embodiments of the present invention include: receiving an advertisement from an advertiser; receiving a target profile defining the type of viewer that should receive the advertisement; receiving notification from users indicative of playback of entertainment content; providing users with the advertisement based upon similarities between a user profile and the target profile, the advertisement being provided by merging the advertisement with the entertainment content; and calculating a charge to the advertiser based upon the number of times the advertisement is provided to users.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box

FIG. 2 is a functional block diagram of a digital set-top box suitable for use with the present invention.

FIG. 3 is a flow chart of a process consistent with a video on demand embodiment of the present invention.

FIG. 4 is a flow chart of a process consistent with a local or remote storage based video playback system.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

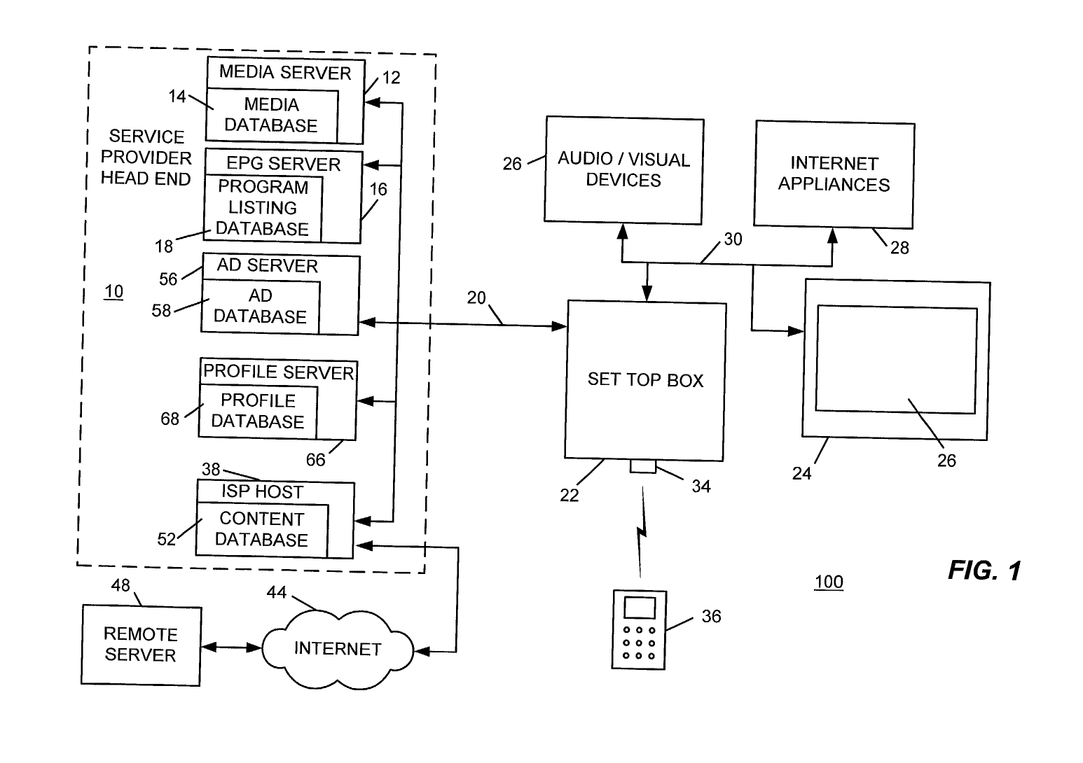

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface-Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

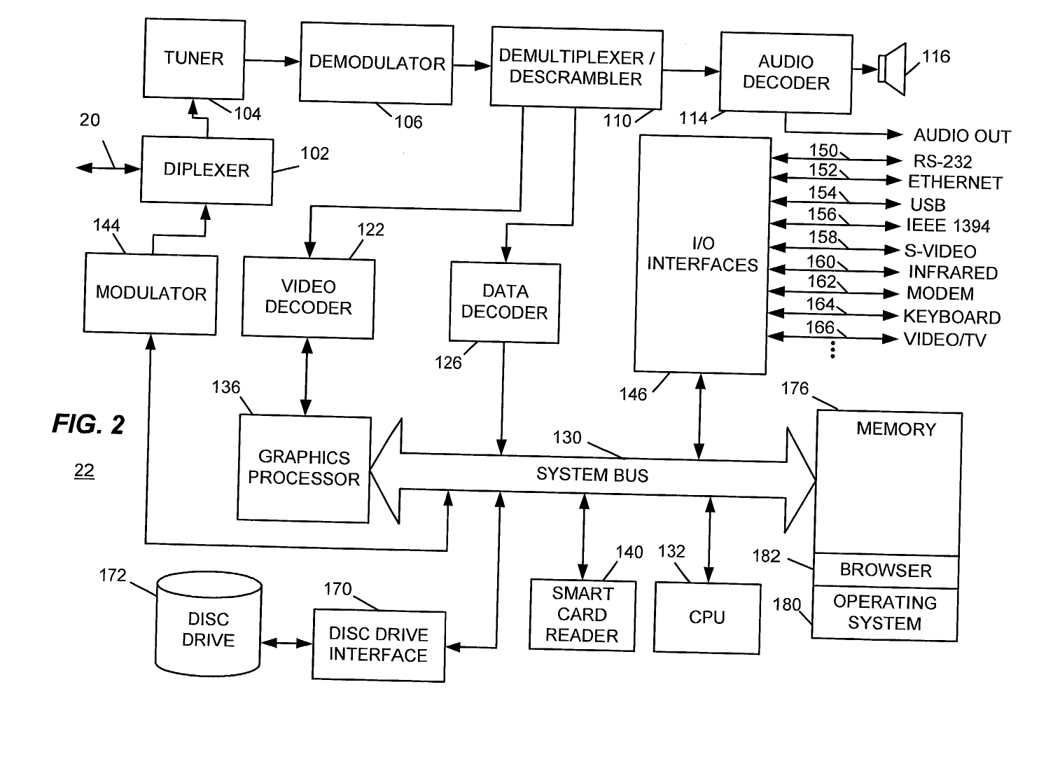

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 1 10 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD RIW drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

In accordance with embodiments of the present invention, the STB can be utilized to enhance the effectiveness of advertisements directed at the viewer of recorded content. This not only enhances the possibility of revenue for the advertiser and the service provider, but can also be used to provide the user with targeted promotional information that is more likely to be of interest to the user and is less repetitive than current advertising techniques. For example, a 25 year-old single male without children can be spared from advertisements for baby food in favor of, for example, advertisements for night clubs or sporting events—that is, advertisements which, demographically speaking, are more likely to be of interest. Moreover, when specific favorite content is played back repeatedly, new or different advertisements can be directed at the user.

Referring back to FIG. 1, in one embodiment of the invention, the service provider 10 head end includes an advertisement server 56 including a database 58 of advertisements supplied by various entities that pay to have advertising distributed to subscribers. In addition a user profile server 66 having a database 68 of user profiles of subscribers is also provided at the service provider 10 head end. In general, the servers 12, 16, 56 and 66 as well as host 38 are described as independent servers, but those skilled in the art will appreciate that the servers operate in a coordinated manner and may in fact be implemented in fewer or more actual computer systems than depicted in FIG. 1.

In general, upon subscribing to a cable or satellite entertainment system or service, the subscriber is asked to provide certain information such as name, address, telephone number etc. As part of this process, the subscriber can also provide a user profile for the subscriber and members of his or her household. Any number of profile parameters can be gathered during a setup process for the system including age, sex, marital status, programming favorites, hobbies, etc. In certain embodiments of the present invention, such data can be used to correlate the user to advertising of most interest to the user. Profile parameters can also be gathered manually, electronically or via an interview and updated periodically.

In accordance with a first embodiment of the invention, consider a Video-On-Demand (VOD) scenario. In this scenario, content is provided by and stored at the service provider 10 at media server 12 within the media database 14. When the user wishes to purchase a VOD selection, the media server 12 retrieves the data from the media database 14 and delivers it to STB 22 for playback to the user. Since the playback is an individual playback for the user, advertisements can be individually selected for the user based upon the user's individual profile. For multiple users of the same system, access codes are authenticated for the particular user selecting the VOD selection in order to assure authorization and payment. As a part of the information exchange during the authentication process (or at another time), the STB 22 can also provide the head end with a viewing history for the current user or household. Thus, the individual user whose access code is associated with the VOD selection can be identified for targeted advertising and his use profile can be updated to reflect recent viewing history. In addition to these factors, advertising can be varied depending upon the content, advertisement history, playback time and date and/or other factors. That is, the particular advertisement associated with the VOD selection is not static and, thus, more likely to be subject to becoming obsolete (e.g., discontinued products or services, events that have already taken place, etc.) or tiring to the viewer.

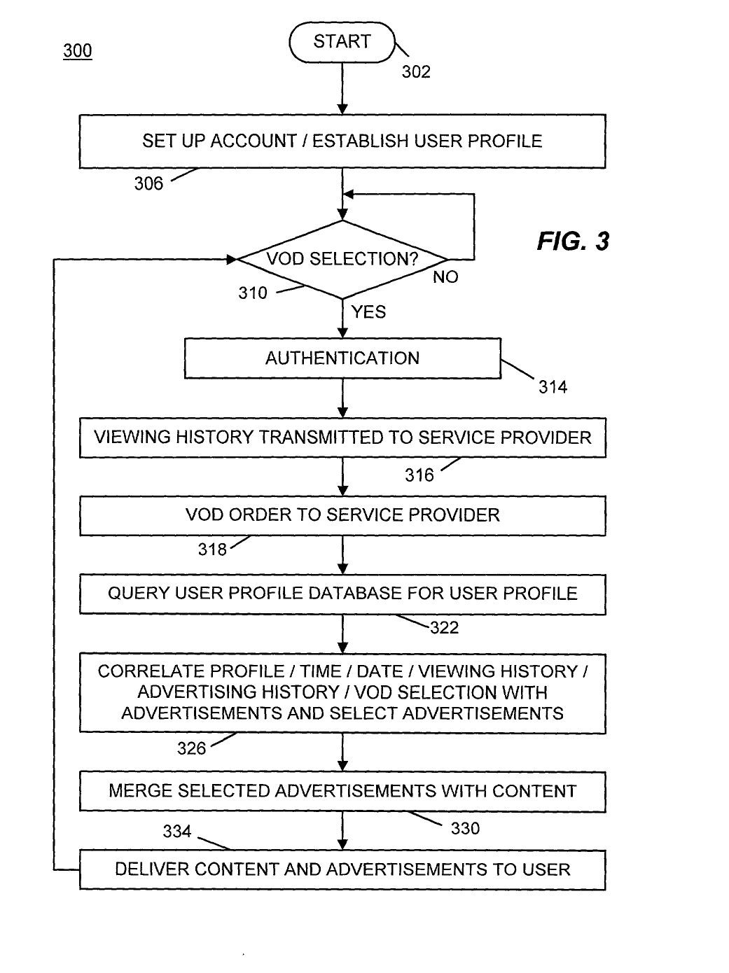

This VOD process is illustrated as 300 in FIG. 3 which starts at 302 and in which the user establishes a profile at 306. The profile can be established as part of the user's registration for service with the service provider 10 and updated periodically. At 310, the user makes a VOD selection to begin the process of playing back content from the service provider 10. At 314, the user is authenticated at the STB 22 using the security features of a smart card as previously described, for example.

Assuming successful authentication at 314, the STB 22 downloads a history of recently viewed programming to the head end for assimilation by the user profile server 66 to refine the characterization of the user's viewing habits at 316. A message is sent to the service provider 10 at 318 to place the authenticated VOD order. The service provider 10 then queries the user profile database 68 of user profile server 66 to obtain profile information relating to the user at 322. The profile information is then used by the advertising server 56 along with the history information, time of day, date, advertisement history and VOD selection to correlate to advertisements stored in the advertisement database 58 that appropriately target the user at 326.

The media server 12 then merges the advertisements selected by the advertising server 66 with the content from the media database 14 at 330 and delivers the content, including embedded targeted advertisements to the user at 334. The process is repeated each time the user selects a new VOD selection so that a new set of advertisements is provided. By way of example, if the user's profile indicates that he is a 26 year old male with an interest in sports and is ordering a sports related VOD selection, advertisements for sports apparel, sporting events and the like are likely of interest. Whereas, if the user is a 56 year-old female with an interest in the arts and the VOD selection is a drama, such advertising would likely have very low effectiveness compared with advertisements for book dealers, museum exhibits and live theater events. In other embodiments, the advertisements can be downloaded separately to the STB 22 and the merging of the VOD selection and the advertisements can be carried out within the STB 22 either in real time during playback or stored with the content at a rate higher than the playback rate for later playback.

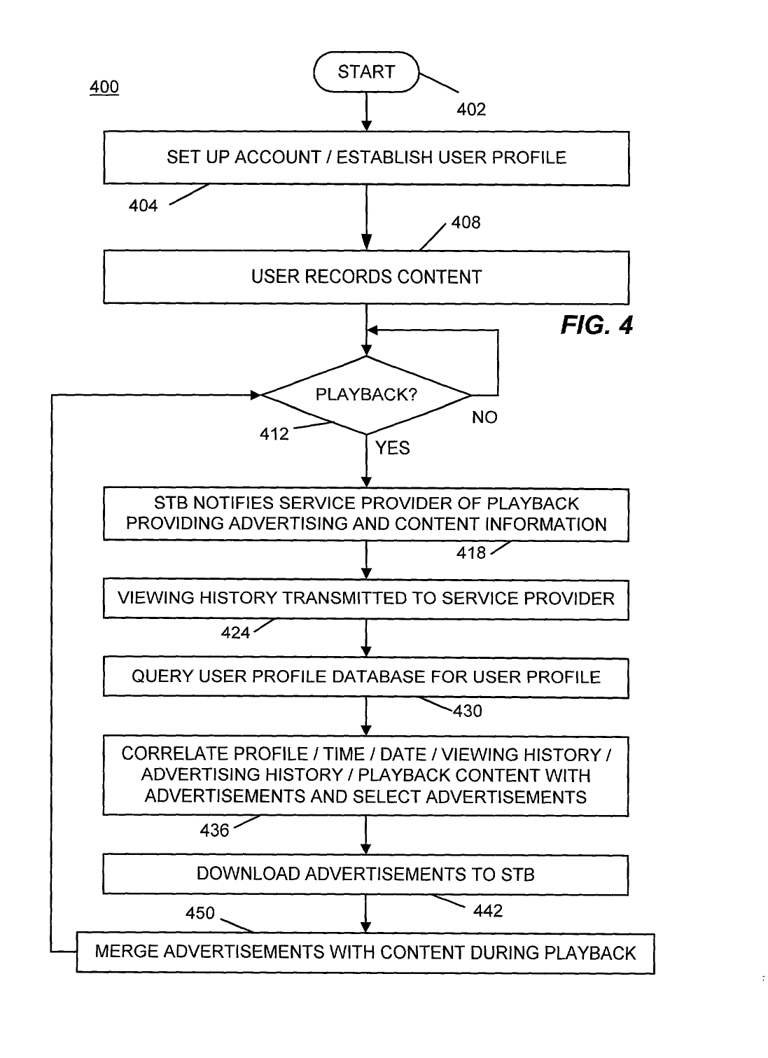

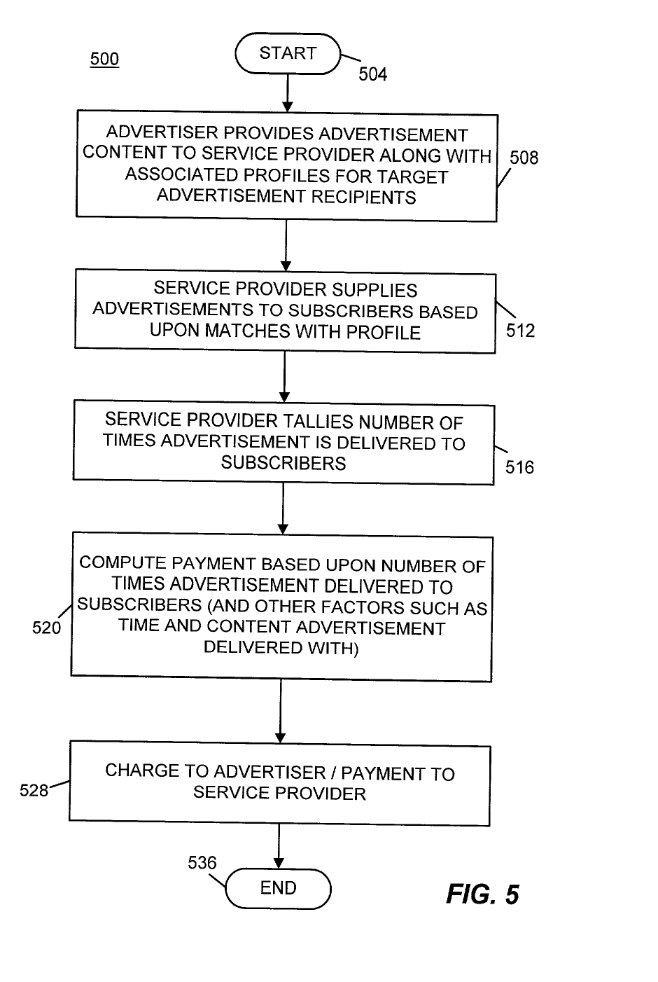

In accordance with a second embodiment of the invention, consider a scenario wherein the user is playing back recorded content. This embodiment, is illustrated in the process shown as 400 in FIG. 4. The process begins at 402 after which the user sets up an account and establishes a user profile at 404. At 408, the user elects to record a particular item of programming content such as a television program. The content can be stored locally on the disc drive 172 of STB 22 or within storage provided in an AN device 26 such as a PVR, personal computer, or other attached device having storage. Alternatively, the content can be stored remotely on storage provided by the service provider 10 or a remote server 48 without limitation.

When the user elects to playback a selection at 412, the STB 22 notifies the service provider 10 of the playback at 418 and provides the service provider with information as to the content being played back as well as information about the advertisements on the content being played back. The content might include recorded advertisements or merely advertisement place holders indicating a location where an advertisement is to be inserted. The viewing history is transmitted to the service provider at 424 as described previously. In this embodiment, a user authentication may not be required, so the STB may not be able to identify the user specifically and may have to use a profile associated the household or all members of the household at 430 as a query entry into the profile server's database 68. In any event, the profile and possibly other information such as date, time, viewing history, content information, advertising history, etc. is correlated at 436 with available advertisements in advertisement server 56 to appropriately select targeted advertisements. The selected advertisements are then downloaded to the STB 22 at 442 and the advertisements are merged with the content at 450 either dynamically during playback or by modification to the stored content to insert the new advertisements. This process is repeated whenever the user makes a selection to playback programming content at 412.

Any available communication avenue between the STB 22 and the service provider 10 (e.g., DOCSIS modem, OOB modem, dial up connection, etc.) can be used to provide the communication needed to implement the present invention. Thus, the messages sent from the STB 22 to alert the service provider 10 of a playback event can be carried out over communication medium 20 using, for example, a message generated by the CPU 132 under program control upon receipt of a playback command from remote controller 36 via the infrared interface (34, 160). The message can be transmitted using an OOB modem or DOCSIS modem forming part of the STB 22. The viewing history is readily accumulated at the STB 22 by monitoring viewing habits of the household and/or particular users and storing information about programs viewed on disc drive 172 for downloading to the service provider 10. When the advertisements are received from the advertisement server 56, they are stored, for example, in disc drive 172 or other available storage and merged with the playback content, for example by CPU 132 operating under program control, either during playback or prior to playback in a manner similar to a word processing mail merge function. In other embodiments, stored advertisements are replaced by overwriting the existing advertisements or substitution during playback.

Any number of factors can be used to refine a target selection of advertisements for a particular viewer to make the advertisements more interesting, more effective and more likely to be viewed. Several factors are described in TABLE 1 below:

TABLE 1

| | HOW THE FACTOR CAN INFLUENCE THE |
|---|---|
| FACTOR | SELECTION OF ADVERTISEMENTS |
| Profile information | can demographically and otherwise categorize the |
| | user, his or her interests and provide direct input |
| | from the user as to preferences |
| Time/date | can be used to assure that obsolete advertisements |
| | are not displayed |
| viewing history | can be used to further refine the user's preference |
| | for programming content and thus interest profile |
| current selection | can be used to optimize pairing of advertising |
| | with programming-i.e. an immediate interest in |
| | the program being viewed may correlate with an |
| | advertisement or category of advertisement's |
| | effectiveness |
| advertisement history | can be used to optimize the frequency any partic- |
| | ular advertisement is provided to a user to |
| | maintain the user's interest without the user |
| | becoming annoyed with the advertisement |
| time | can be used to optimize advertisement of goods |
| | that might be particularly attractive at a given |
| | time of day-e.g. late evening might correlate well |
| | to fast food delivery and morning might correlate |
| | well to coffee advertisements can be used as a |
| | factor in determining how much a particular |
| | advertisement should cost an advertiser |

Of course, those skilled in the art will appreciate that the above examples of the factors that can be used to select a particular advertisement are merely illustrative of the many factors that an advertiser might correlate to the effectiveness of an advertisement.

In view of the advantages to advertisers, the present invention can also be used as the basis of a business model in which advertisers pay for advertising based upon frequency and times of playback. Thus, in accordance with FIG. 5, a business model can be developed as described by process 500. The process starts at 504 and at 508, an advertiser provides advertisement content to the service provider 10 along with associated profiles for target advertisement recipients. The service provider 10, in accord with agreed upon terms, supplies the advertisement to subscribers that match the profile provided by the advertiser at 512 in accord with the processes previously described in connection with the present invention. The service provider, at 516, tallies each time the advertisement is supplied to a subscriber and further tabulates the data broken down by such factors as time and programming so that charges for the advertisement's distribution can be computed based upon time of presentation of the advertisement and programming content that the advertisement accompanied in an agreed upon manner at 520.

At 528 the charges are presented to the advertiser for payment and the process ends at 536. Of course, refinements can be made to this process without departing from the basic process. For example, the service provider can run the advertisement profile against viewing histories for a previous period of time to determine an estimate of the cost for the advertiser. Moreover, the advertiser, upon gaining experience with the response to the advertisement can refine the advertisement and/or the profile to enhance effectiveness. Any of the factors shown in TABLE 1 can be used to facilitate a match with the advertisement profile in accordance with the description of the invention provided above.

While the above invention description suggests that the advertisements be modified or varied in accordance with certain disclosed parameters, those skilled in the art will appreciate that any number of suitable triggers can be used to assert a particular change in an advertisement. For example, in other embodiments, a STB 22 can detect certain indications of a user's boredom (e.g., constant random shifting of channels) and can present a targeted advertisement, for example, for pay per view programming, to the user. Those skilled in the art will appreciate that many other factors can be used to trigger particular advertisements or types of advertisements without departing from the present invention.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form, and can be stored on any suitable electronic storage medium. However, those skilled in the art will appreciate that the processes described above can be implemented in any number of variations and in many suitable programming languages without departing from the present invention. For example, the order of certain operations carried out can often be varied, portions can be deleted and additional operations can be added without departing from the invention. Error trapping can be added and/or enhanced and variations can be made in user interface and information presentation without departing from the present invention. Such variations are contemplated and considered equivalent. While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of playback of stored entertainment content, comprising:
notifying a service provider of a playback of the stored entertainment content;
receiving an advertisement from an advertising server; and
merging the advertisement with the stored entertainment content so that both the advertisement and the stored entertainment content are played back.

2. The method according to claim 1, wherein merging the advertisement with the stored entertainment content comprises inserting the advertisement in place of a stored advertisement forming a part of the entertainment content.

3. The method according to claim 2, wherein the inserting takes place during real-time playback of the entertainment content.

4. The method according to claim 1, wherein merging the advertisement with the stored entertainment content comprises inserting the advertisement at a location of an advertisement place holder forming a part of the entertainment content.

5. The method according to claim 4, wherein the inserting takes place during real time playback of the entertainment content .

6. The method according to claim 1, wherein the stored entertainment content is stored at a service provider site.

7. The method according to claim 1, wherein the stored entertainment content is stored in a set-top box.

8. The method according to claim 1, wherein the stored entertainment content is stored in storage device coupled to a set-top box.

9. The method according to claim 1, further comprising transmitting a viewing history to the service provider prior to receiving the advertisement.

10. A method of delivering advertisements to a user, comprising: receiving a message from a set-top box indicating initiation of playback of stored entertainment content;
selecting an advertisement based on a user profile for the user; and
transmitting the advertisement to the set-top box to be merged with the entertainment content.

11. The method according to claim 10, further comprising merging the advertisement with the stored entertainment content.

12. The method according to claim 10, further comprising merging the advertisement with the stored entertainment content by inserting the advertisement in place of a stored advertisement forming a part of the stored entertainment content.

13. The method according to claim 12, wherein the inserting takes place during real-time playback of the stored entertainment content.

14. The method according to claim 10, further comprising merging the advertisement with the stored entertainment content by inserting the advertisement at a location of an advertisement place holder forming a part of the stored entertainment content.

15. The method according to claim 14, wherein the inserting takes place during real-time playback of the stored entertainment content.

16. The method according to claim 10, wherein the stored entertainment content is stored at a service provider site.

17. The method according to claim 10, wherein the stored entertainment content is stored in a set-top box.

18. The method according to claim 10, wherein the stored entertainment content is stored in a storage device coupled to a set-top box.

19. The method according to claim 10, further comprising receiving a viewing history from the set-top box prior to selecting the advertisement.

20. The method according to claim 10, wherein the selecting further comprises selecting the advertisement based upon information relating to the stored entertainment content being played back.

21. The method according to claim 10, wherein the selecting further comprises selecting the advertisement based upon a playback time.

22. The method according to claim 10, wherein the selecting further comprises selecting the advertisement based upon a playback date.

23. The method according to claim 10, wherein the selecting further comprises selecting the advertisement based upon information relating to a viewing history of the user.

24. The method according to claim 23, wherein the viewing history is transmitted from the set-top box to a service provider.

25. The method according to claim 10, wherein the selecting further comprises selecting the advertisement based upon information relating to an advertising history for the user.

26. The method according to claim 10, wherein the selecting further comprises selecting the advertisement based upon user profile information relating to a plurality of users.

27. A set-top box, comprising:
an input interface receiving a signal indicating that a user has initiated a playback of stored entertainment content;
means for notifying a service provider of the initiation of the playback of stored entertainment content;
means for receiving a selected advertisement from the service provider; and
a programmed processor that merges the selected advertisement with the entertainment content so that the entertainment content is played back with the selected advertisement.

28. The apparatus according to claim 27, wherein the programmed processor that merges the advertisement with the stored entertainment content comprises means for inserting the advertisement in place of a stored advertisement forming a part of the entertainment content.

29. The apparatus according to claim 28, wherein the means for inserting inserts the advertisement during real-time playback of the entertainment content.

30. The apparatus according to claim 27, wherein the programmed processor that merges the advertisement with the stored entertainment content comprises means for inserting the advertisement at a location of an advertisement place holder forming a part of the entertainment content.

31. The apparatus according to claim 30, wherein the means for inserting inserts the advertisement during real time playback of the entertainment content.

32. The apparatus according to claim 27, wherein the stored entertainment content is stored at a service provider site.

33. The apparatus according to claim 27, further comprising a disc drive forming a part of the set-top box, and wherein the stored entertainment content is stored in the disc drive.

34. The apparatus according to claim 27, wherein the stored entertainment content is stored in storage device coupled to the set-top box.

35. The apparatus according to claim 27, further comprising means for transmitting a viewing history to the service provider prior to receiving the advertisement.

36. A system for delivery of advertisements, comprising:
means for receiving a message from a set-top box indicative of a user's selection of playback of stored entertainment content;
a user profile server for storing a user profile of the user;
an advertisement server receiving the user profile and supplying an advertisement selected in accordance with the user profile; and
means for transmitting the advertisement to the set-top box for merged playback with the entertainment content.

37. The apparatus according to claim 36, further comprising a media server that merges the advertisement with the stored entertainment content before transmission to the set-top box.

38. The apparatus according to claim 36, wherein the merging of the advertisement with the stored entertainment content is carried out by inserting the advertisement in place of a stored advertisement forming a part of the entertainment content.

39. The apparatus according to claim 38, wherein the inserting takes place during real-time playback of the entertainment content.

40. The apparatus according to claim 36, wherein the merging of the advertisement with the stored entertainment content is carried out by inserting the advertisement at a location of an advertisement place holder forming a part of the entertainment content.

41. The apparatus according to claim 40, wherein the inserting takes place during real time playback of the entertainment content.

42. The apparatus according to claim 36, wherein the stored entertainment content is stored in a media server at a service provider site.

43. The apparatus according to claim 36, wherein the stored entertainment content is stored in the set-top box.

44. The apparatus according to claim 36, wherein the stored entertainment content is stored in a storage device coupled to a set-top box.

45. The apparatus according to claim 36, further comprising means for receiving a viewing history prior to selecting the advertisement.

46. The apparatus according to claim 36, wherein the selecting further comprises selecting the advertisement based upon information relating to the content being played back.

47. The apparatus according to claim 36, wherein the selecting further comprises selecting the advertisement based upon a playback time.

48. The apparatus according to claim 36, wherein the selecting further comprises selecting the advertisement based upon a playback date.

49. The apparatus according to claim 36, wherein the selecting further comprises selecting the advertisement based upon information relating to a viewing history of the user.

50. The apparatus according to claim 49, wherein the viewing history is transmitted from the set-top box to a service provider.

51. The apparatus according to claim 36, wherein the selecting further comprises selecting the advertisement based upon information relating to an advertising history for the user.

52. The apparatus according to claim 36, wherein the selecting further comprises selecting the advertisement based upon user profile information relating to a plurality of users.

53. An electronic storage medium storing instructions which, when executed on a programmed processor, carry out a process of playback of stored entertainment content, comprising:
notifying a service provider of a playback of the stored entertainment content;
receiving an advertisement from an advertising server; and
merging the advertisement with the stored entertainment content so that both the advertisement and the stored entertainment content are played back.

54. The storage medium according to claim 53, wherein merging the advertisement with the stored entertainment content comprises inserting the advertisement in place of a stored advertisement forming a part of the stored entertainment content.

55. The storage medium according to claim 54, wherein the inserting takes place during real-time playback of the stored entertainment content.

56. The storage medium according to claim 53, wherein merging the advertisement with the stored entertainment content comprises inserting the advertisement at a location of an advertisement place holder forming a part of the stored entertainment content.

57. The storage medium according to claim 56, wherein the inserting takes place during real-time playback of the stored entertainment content.

58. The storage medium according to claim 53, wherein the process further comprising transmitting a viewing history to the service provider prior to receiving the advertisement.

59. An electronic storage medium storing instructions which, when executed on a programmed processor, carry out a process of delivering advertisements to a user, comprising:
receiving a message from a set-top box indicating initiation of playback of stored entertainment content;
selecting an advertisement based on a user profile for the user; and
transmitting the advertisement to the set-top box to be merged with the entertainment content.

60. The storage medium according to claim 59, wherein the process further comprises merging the advertisement with the stored entertainment content.

61. The storage medium according to claim 59, wherein the process further comprises merging the advertisement with the stored entertainment content by inserting the advertisement in place of a stored advertisement forming a part of the stored entertainment content.

62. The storage medium according to claim 61, wherein the inserting takes place during real-time playback of the stored entertainment content.

63. The storage medium according to claim 59, wherein the process further comprises merging the advertisement with the stored entertainment content by inserting the advertisement at a location of an advertisement place holder forming a part of the stored entertainment content.

64. The storage medium according to claim 63, wherein the inserting takes place during real-time playback of the stored entertainment content.

65. The storage medium according to claim 59, wherein the selecting further comprises selecting the advertisement based upon information relating to the entertainment content being played back.

66. The storage medium according to claim 59, wherein the selecting further comprises selecting the advertisement based upon a playback time.

67. The storage medium according to claim 59, wherein the selecting further comprises selecting the advertisement based upon a playback date.

68. The storage medium according to claim 59, wherein the selecting further comprises selecting the advertisement based upon information relating to a viewing history of the user.

69. The storage medium according to claim 59, wherein the selecting further comprises selecting the advertisement based upon information relating to an advertising history for the user.

70. The storage medium according to claim 59, wherein the selecting further comprises selecting the advertisement based upon user profile information relating to a plurality of users.

71. A method of doing business, comprising:
receiving an advertisement from an advertiser;
receiving a target profile defining the type of viewer that should receive the advertisement;
receiving notification from users indicative of playback of entertainment content;
providing users with the advertisement based upon similarities between a user profile and the target profile the advertisement being provided by merging the advertisement with the entertainment content; and
calculating a charge to the advertiser based upon the number of times the advertisement is provided to users.

72. The method according to claim 71, further comprising calculating the charge based upon times that the advertisement is provided to users.

73. The method according to claim 71, wherein the entertainment content is stored at a service provider site.

74. The method according to claim 71, wherein the entertainment content is stored in a set-top box.

75. The method according to claim 71, wherein the entertainment content is stored in a storage device coupled to a set-top box.

76. The method according to claim 71, wherein providing the advertisement is further based upon a viewing history for the user.

77. The method according to claim 71, wherein providing the advertisement is further based upon information relating to the entertainment content being played back.

78. The method according to claim 71, wherein providing the advertisement is further based upon a playback time.

79. The method according to claim 71, wherein providing the advertisement is further based upon a playback date.

80. The method according to claim 71, wherein providing the advertisement is further based upon information relating to an advertising history for the user.

81. The method according to claim 71, wherein providing the advertisement is further based upon user profile information relating to a plurality of users.
